(19) United States
(12) Patent Application Publication
(10) Pub. No.: US 2022/0205425 A1
(43) Pub. Date: Jun. 30, 2022

(54) WIND TURBINE SYSTEM USING PREDICTED WIND CONDITIONS AND METHOD OF CONTROLLING WIND TURBINE

(71) Applicant: POSTECH Research and Business Development Foundation, Pohang-si (KR)

(72) Inventors: Donghyun YOU, Pohang-si (KR); Taewan KIM, Seoul (KR); Sejin KIM, Pohang-si (KR); Jeonghwan SONG, Yangsan-si (KR)

(21) Appl. No.: 17/230,235

(22) Filed: Apr. 14, 2021

(30) Foreign Application Priority Data
Dec. 29, 2020 (KR) 10-2020-0186619

(51) Int. Cl. F03D 7/04; F03D 17/00

(52) U.S. Cl. CPC F03D 7/042; F03D 17/00; F05B 2270/32; F05B 2270/101; F05B 2270/1033; F05B 2270/70

(57) ABSTRACT

According to the disclosure, an artificial intelligence (AI) model receives a power production amount, a power production efficiency, a control variable and the like states as input information through information exchange between a wind turbine and the AI model, and therefore it is possible to provide a control method using the AI model with regard to even the wind turbine given no power coefficient.

### CROSS-REFERENCE TO RELATED the APPLICATION

This application is based on and claims priority under 35 U.S.C. § 119 to Korean Patent Application No. 10-2020-0186619 filed on Dec. 29, 2020 in the Korean Intellectual Property Office, the disclosure of which is incorporated by reference herein in its entirety.

### BACKGROUND

### Field

The disclosure relates to a wind-turbine system using predicted wind conditions and a method of controlling a wind turbine, and more particularly to a wind-turbine control algorithm using an artificial intelligence (AI) model for predicting wind conditions to maximize efficiency of power production.

### Description of the Related Art

A wind turbine refers to an apparatus for conversion from kinetic energy of air into electric energy. The wind turbine has been widely employed as one of ecofriendly generators in terms of using unlimited energy, i.e., harnessing wind.

A control algorithm for a conventional wind turbine is based on a theoretically modeled power-coefficient curve, presently measured wind conditions, and a wind-turbine rotating speed. It has been known that the efficiency of the wind turbine is theoretically maximized in this case. However, the control algorithm uses fluid information presently measured on the assumption that a wind direction and a wind speed are not largely varied, and therefore there is a difference between a theoretical control efficiency and an actually measured control efficiency. To solve a problem that wind turbine control performance is degraded by unsteady turbulent effects of wind conditions, domestic and foreign research has been conducted to enhance stability of pitching/yawing/tilting control with regard to the presently measured wind conditions.

In connection with such a conventional wind turbine, Korean Patent Publication No. 2017-0052339 has been disclosed. The conventional wind turbine has been developed to quickly cope with a sudden change in the wind direction under real-time control.

However, such a related art uses only information about presently measured wind conditions, and thus has a limit to improvement in a power production efficiency due to the wind conditions unstably changing over time.

### SUMMARY

An aspect of the disclosure is to provide a wind-turbine system using predicted wind conditions and a wind-turbine control method, in which a power production efficiency is maximized by controlling a wind turbine based on the predicted wind conditions to overcome the foregoing control limit of the conventional wind turbine.

According to an embodiment of the disclosure, there is provided a wind turbine system using predicted wind conditions, including: a wind turbine; a plurality of wind-condition measuring sensors spaced apart at a predetermined distance from a reference position where the wind turbine is placed, and configured to obtain time-series wind-condition data; a predicted wind-condition data generator configured to generate predicted wind-condition data at the reference position based on the time-series wind-condition data obtained by the wind-condition measuring sensors; a control algorithm learner configured to generate a control variable by learning a control algorithm applied to the wind turbine to improve a power production efficiency of the wind turbine based on the predicted wind-condition data; and a controller configured to control the wind turbine based on the control variable.

Meanwhile, the predicted wind-condition data generator may be configured to learn using generative adversarial networks (GANs) to generate predicted wind-condition data.

Meanwhile, the control algorithm learner may be configured to receive data about present states of the wind turbine from the wind turbine, and learn change in the power production efficiency corresponding to change in the control variable.

Further, the control algorithm learner may be configured to provide feedback on change in power production in a form of a loss function, and set the control variable to minimize a result value of the loss function.

In this case, the control variable includes at least one among a pitch and rotating speed of a blade, and yaw and tilt angles of a tower in the wind turbine.

Further, the control algorithm learner may be configured to make the AI learn with deep deterministic policy gradient (DDPG).

Meanwhile, the controller may be configured to measure present wind conditions through a sensor provided in the wind turbine, and control the wind turbine by reflecting an error between the predicted wind-condition data and the present wind-condition value.

In addition, there is provided a wind turbine control method using predicted wind conditions, including: obtaining time-series wind-condition data at many places within a predetermined distance from a reference position where the wind turbine is placed; generating predicted wind-condition data at the reference position after a present point in time based on the time-series wind-condition data; generating a control variable by learning a control algorithm applied to the wind turbine to improve a power production efficiency of the wind turbine based on the predicted wind-condition data; and controlling the wind turbine based on the generated control variable.

Meanwhile, the predicted wind-condition data may include information about wind conditions of a predetermined period from a present point in time to the future, which is generated based on generative adversarial networks (LANs).

In this case, the learning of the control algorithm may be performed based on data about present states of the wind turbine received from the wind turbine, and change in the power production efficiency corresponding to change in the control variable.

Meanwhile, the learning of the control algorithm may be performed to provide feedback on change in power production in a form of a loss function, and set the control variable to minimize a result value of the loss function.

In this case, the control variable may include at least one among a pitch and rotating speed of a blade, and yaw and tilt angles of a tower in the wind turbine.

Meanwhile, the learning of the control algorithm is performed by making the AI learn with deep deterministic policy gradient (DDPG).

Meanwhile, the controlling of the wind turbine may include measuring present wind conditions through a sensor provided in the wind turbine, and updating the control variable by reflecting an error between the predicted wind-condition data and the present wind-condition value.

### BRIEF DESCRIPTION OF THE DRAWINGS

The above and/or other aspects will become apparent and more readily appreciated from the following description of embodiments, taken in conjunction with the accompanying drawings, in which:

FIG. 1 is a conceptual view of control for a wind turbine;

FIG. 2 is a block diagram of a wind turbine system using predicted wind conditions according to an embodiment of the disclosure;

FIG. 3 is a conceptual view of an artificial intelligence (AI) model for predicting wind conditions;

FIG. 4 is a conceptual view of an AI model for determining a control algorithm; and

FIG. 5 is a flowchart of a wind-turbine control method based on predicted wind conditions according to an embodiment of the disclosure.

### DETAILED DESCRIPTION OF EMBODIMENTS

Below, a wind-turbine system using predicted wind conditions and a wind-turbine control method according to an embodiment of the disclosure will be described in detail with reference to accompanying drawings. Elements described in the following embodiments may be called other names in relevant fields. However, if the elements are similar or identical in terms of their functions, they may be regarded as equivalents even in alternative embodiments. Further, signs assigned to the elements are given for convenience of description. However, content on the drawings with these given signs do not limit the elements to a range in the drawings. Likewise, even though the elements on the drawings are partially modified according to alternative embodiments, they having functional similarity and identity may be regarded as equivalents. Further, if those skilled in the art recognizes natural involvement of elements, descriptions of the elements will be omitted.

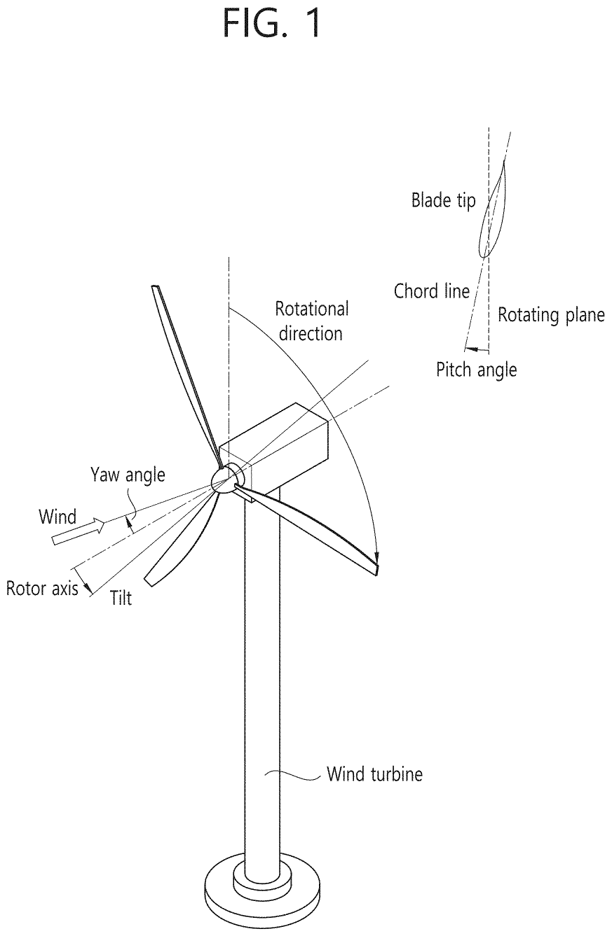

FIG. 1 is a conceptual view of control for a wind turbine.

Referring to FIG. 1, the wind turbine is configured with controllable angles (yaw and tilt) of a turbine, and a controllable angle (pitch) and rotating speed of a blade to thereby maximize efficiency of power production depending on wind speeds and wind directions.

A conventional wind turbine uses a control algorithm to control the efficiency of the power production based on information about presently measured wind conditions. In this case, the control algorithm is based on the assumption that the wind conditions are not largely varied over time, and therefore an actual efficiency determined under the control is lower than a theoretical efficiency. In a wind section of high wind speed, in which power production is high, there is a bigger difference between actual power production and theoretical power production because the wind conditions are largely varied over time. Further, when the wind speed is higher than a rated wind speed, a pitching control algorithm is used to maintain rated power production but has a problem of adversely affecting the structural stability of the wind turbine because it is difficult to control the wind turbine in real time corresponding to a suddenly changing wind speed.

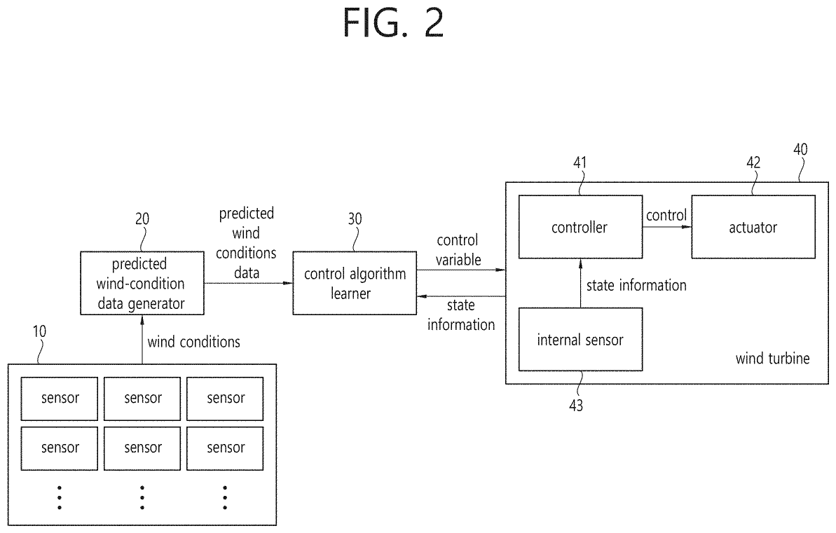

FIG. 2 is a block diagram of a wind turbine system using predicted wind conditions according to an embodiment of the disclosure.

Referring to FIG. 2, to solve the foregoing conventional problems, the wind turbine system using predicted wind conditions according to an embodiment of the disclosure includes a wind turbine 40, a wind-condition measuring sensor 10, a predicted wind-condition data generator 20, a control algorithm learner 30, and a controller 41.

The wind turbine 40 may be achieved by a conventional wind turbine 40 described with reference to FIG. 1. The wind turbine 40 may be configured to control angles and control a pitching angle and rotating speed of a blade. Further, the wind turbine 40 may include an internal sensor 43 installed at a reference position and detecting a wind direction and wind strength at the reference position. The wind turbine 40 may include the controller 41 (to be described later), and include a actuator 42 for position adjustment and blade adjustment. Meanwhile, when a plurality of wind turbines 40 are provided in the system, the internal sensors 43 of the wind turbines 40 installed at different positions may function as the wind-condition measuring sensor 10. However, such configuration of the wind turbine 40 may include a generator generally and widely used for power production and the configuration of the wind turbine 40, and thus more detailed descriptions thereof will be omitted.

The wind-condition measuring sensor 10 may be provided at a plurality of places spaced apart from the reference position where the foregoing wind turbine 40 is positioned. Thus, data about the presently measured wind conditions is obtained at the plurality of places. The wind-condition measuring sensor 10 may for example include an anemometer, a pitot tube, or the like widely used for measuring a wind direction.

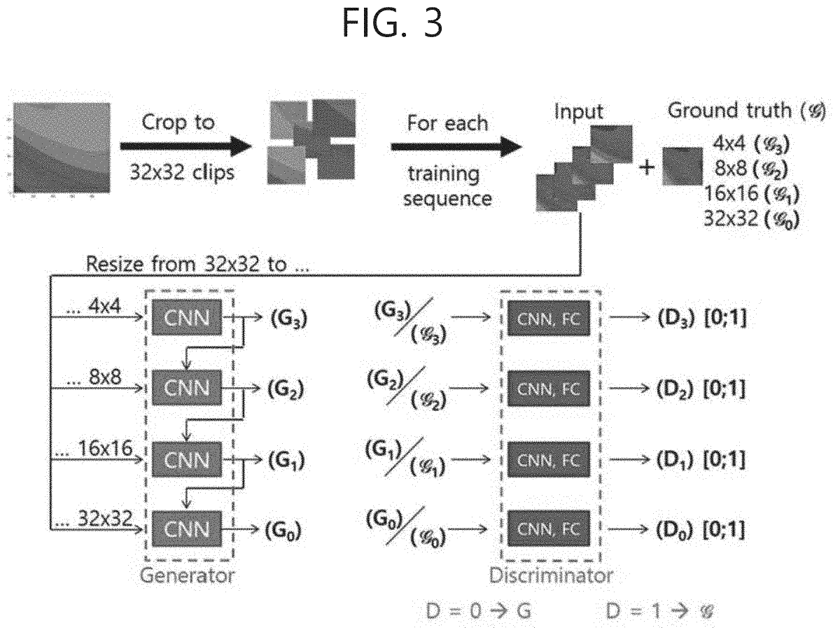

The predicted wind-condition data generator 20 is configured to receive data from the plurality of wind-condition measuring sensors 10 and generate predicted wind-condition data. In this case, the predicted wind-condition data may be generated by teaching artificial intelligence (AI). In this regard, detailed descriptions will be made later with reference to FIG. 3.

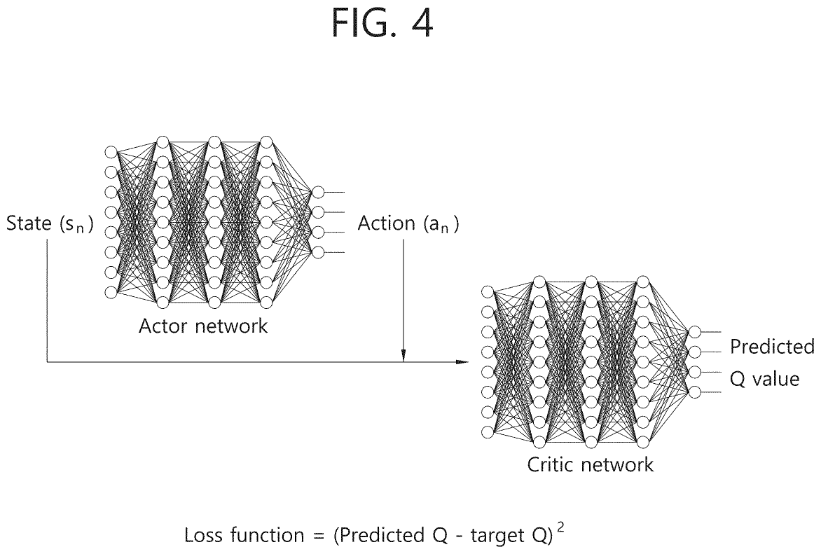

The control algorithm learner 30 is configured to generate the control algorithm of the wind turbine 40 based on the predicted wind-condition data generated from the foregoing predicted wind-condition data generator 20. The control algorithm learner 30 may learn the control algorithm to maximize the power production efficiency of the wind turbine 40 based on the predicted wind-condition data. In this regard, detailed descriptions will be made later with reference to FIG. 4.

The controller 41 is configured to receive a control variable newly generated based on the predicted wind-condition data after the learning of the control algorithm learner 30 and control the wind turbine 40. Based on output of the controller 41, the actuator 42 may for example be driven to adjust the positions (yaw and tilt) of the wind turbine or the angle or rotating speed of the blade.

Below, the predicted wind-condition data generator 20 will be described in detail with reference to FIG. 3.

FIG. 3 is a conceptual view of an AI model for predicting wind conditions.

Referring to FIG. 3, the predicted wind-condition data generator 20 is configured to teach AI for predicting future wind conditions based on wind conditions varying in real time. The predicted wind-condition data generator 20 may learn for example using generative adversarial networks (GANs). In this case, time-series wind-condition data obtained at the plurality of places by the wind-condition measuring sensor 10 is used to learn space-time features of wind, thereby predicting future wind-conditions with high accuracy.

Meanwhile, the Navier-Stokes governing equations for fluids, which describe flow of wind, are functions of time and space, and thus employ the time-series wind-condition data obtained at many places in order to improve the accuracy of the predicted wind conditions. The AI model provided in the predicted wind-condition data generator 20 extracts very numerous pieces of data smaller than original data in space and time and then uses the extracted data. Thus, space and time features the corresponding wind-condition data has are effectively learned, thereby having an effect on parallelizing data and efficiently carrying out learning in consideration of computation costs.

When the predicted wind-condition data is used, it is possible to quickly cope with predicted sudden-change in wind conditions, but the reliability of the predicted wind-condition data becomes lower as the wind conditions are more suddenly changed. In other words, an error increases in this case. Here, a predicted value, which involves the error, may generate an error-robust control model, thereby maintaining a high efficiency. However, even though the robust control AI model is generated, the smaller the error between the predicted wind-condition data and actual data, the more preferable.

The predicted wind-condition data generator 20 generates the predicted wind-condition data of high reliability based on the past and present wind-condition data measured at the plurality of places by the AI, and transmits the predicted wind-condition data to a control algorithm generator.

Below, the control algorithm learner 30 will be described with reference to FIG. 4.

FIG. 4 is a conceptual view of an AI model for determining a control algorithm.

Referring to FIG. 4, the control algorithm learner 30 is configured to designate a control value ACTION based on an input of a present state STATE. The state used as the input needs to be changed so that the control algorithm learner 30 can learn a control algorithm for the maximum power production of the wind turbine 40 because a graph outline of a power coefficient is varied depending on the structure of the wind turbine 40.

For example, a pitch angle and rotating speed of a blade, yaw and tilt angles of a tower, and a present power production efficiency in the wind turbine 40 may be used as the states STATE. When a control value ACTION is designated based on these states, the present state of the wind turbine 40 may also be varied depending on the control value.

In this case, the control algorithm learner collects information about how the actual power production changes as the learned and generated control algorithm controls the wind turbine based on the predicted wind condition data.

The control algorithm learner 30 may receive feedback on the power production, which is varied depending on the control algorithm, in the form of a loss function. The control algorithm learner 30 determines the control algorithm to minimize the loss function for the whole future period.

For example, the control algorithm learner 30 may use an error-robust AI model to generate a control algorithm because the predicted wind-condition data involves the error as compared with the actual wind-condition data as described above. Here, the control algorithm may for example be generated through part of enhanced learning, i.e., deep deterministic policy gradient (DDPG). When the control algorithm is generated, a control variable for present control is generated based on the predicted wind-condition data, and transmitted to the wind turbine 40. In the wind turbine 40, the actuator 42 is controlled based on the received control variable to thereby maximize a power production efficiency. In this case, the error of the wind-condition data at the reference position, i.e., the actual wind turbine 40 may be reflected by the internal sensor 43, thereby carrying out the control.

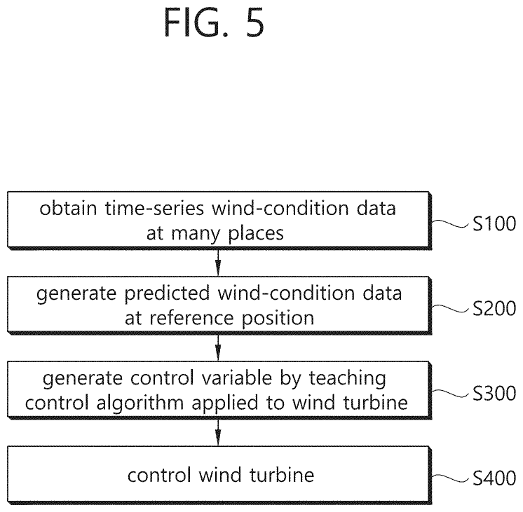

Below, a method of controlling a wind turbine based on predicted wind conditions according to another embodiment of the disclosure will be described with reference to FIG. 5.

FIG. 5 is a flowchart of a wind-turbine control method based on predicted wind conditions according to an embodiment of the disclosure.

Referring to FIG. 5, the wind-turbine control method based on the predicted wind conditions according to the disclosure may include steps of measuring time-series wind-condition data at many places (S100), generating predicted wind-condition data at a reference position (S200), generating a control variable by teaching a control algorithm applied to the wind turbine (S300), and controlling the wind turbine (S400).

The step S100 of measuring the time-series wind-condition data at many places (S100) corresponds to a step of collecting the past and present time-series wind-condition data at a plurality of places spaced apart at a predetermined distance from the reference position where the wind turbine is installed.

The step S200 of generating the predicted wind-condition data at the reference position corresponds to a step of generating the future wind-condition data predicted at the reference position after the present point in time based on the time-series wind-condition data. This step S200 may be performed by making the AI learn as described in FIG. 3. For example, the predicted wind-condition data generator is configured to predict future wind conditions based on the wind conditions varying in real time by making the AI learn. The predicted wind-condition data generator may for example use the GANs to do learning. In this case, the time-series wind-condition data measured by the wind condition sensors at a plurality of places is used to learn space and time features of wind, thereby predicting the future wind conditions with high accuracy.

In the step S300 of generating a control variable by teaching a control algorithm applied to the wind turbine (S300), an AI model designates a control value ACTION by receiving the present state STATE, and learns by changing the state used as an input because a graph outline of a power coefficient is varied depending on the structure of the wind turbine. In this case, the state used as the input may include data obtained from the predicted wind-condition data and the states of the wind turbine based on the data. Here, the control value changes the present states, and information about how power production changes is collected and learned in real time when the control algorithm is designed based on the predicted wind-condition data. Meanwhile, such learning of the AI may use part of enhanced learning, i.e., the DDPG as described above.

When the control algorithm is generated by learning, a control variable is generated based on the control algorithm and the predicted wind-condition data. The generated control variable is transmitted to the wind turbine.

The step S400 of controlling the wind turbine corresponds to a step of controlling at least one among the direction/position of the wind turbine and the angle and rotating speed of a blade by operating a actuator based on the received control variable. In this case, the control may be carried out based on a signal fed back from an internal sensor provided in the wind turbine. In this case, the control may be implemented as the control variable is updated with the feedback signal.

As described above, according to the disclosure, a wind turbine system using predicted wind conditions and a wind turbine control method using predicted wind conditions can use a prediction AI model to previously obtain wind-condition data over time in an area where the wind turbine is placed. The AI model for predicting the wind conditions continuously learns the wind conditions in the corresponding area, and thus provides the wind-condition data of high reliability.

By using the AI model for controlling the wind turbine, a control algorithm for the maximum efficiency of the wind turbine may be derived under the predicted wind conditions. Because not only the present wind conditions but also the future wind conditions are taken into account, stable control can be performed over time, and robust control can be performed with regard to an error between the predicted wind conditions and the actual wind conditions.

Because the AI model receives a power production amount, a power production efficiency, a control variable and the like states as input information through information exchange between the wind turbine and the AI model, it is possible to generalize and apply the control using the AI model to even the wind turbine given no power coefficient.

According to the disclosure, the wind turbine system using the predicted wind conditions and the wind turbine control method using the predicted wind conditions can use the AI model for the prediction to previously obtain the wind-condition data over time in an area where the wind turbine is placed. The AI model for predicting the wind conditions continuously learns the wind conditions in the corresponding area, thereby providing the wind-condition data of high reliability.

The AI model for controlling the wind turbine may be used to derive a control algorithm for the maximum efficiency of the wind turbine under the predicted wind conditions. Because not only the present wind conditions but also the future wind conditions are used, stable control can be performed over time, and robust control can be performed with regard to an error between the predicted wind conditions and the actual wind conditions.

The AI model receives a power production amount, a power production efficiency, a control variable and the like states as input information through information exchange between the wind turbine and the AI model, and therefore it is possible to generalize and apply the control using the AI model to even the wind turbine given no power coefficient.

Although a few embodiments have been shown and described, it will be appreciated by those skilled in the art that changes may be made in these embodiments without departing from the principles and spirit of the invention, the scope of which is defined in the appended claims and their equivalents.

What is claimed is:

1. A wind turbine system using predicted wind conditions, comprising:
a wind turbine;
a plurality of wind-condition measuring sensors spaced apart at a predetermined distance from a reference position where the wind turbine is placed, and configured to obtain time-series wind-condition data;
a predicted wind-condition data generator configured to generate predicted wind-condition data at the reference position based on the time-series wind-condition data obtained by the wind-condition measuring sensors;
a control algorithm learner configured to generate a control variable by learning a control algorithm applied to the wind turbine to improve a power production efficiency of the wind turbine based on the predicted wind-condition data; and
a controller configured to control the wind turbine based on the control variable.

2. The wind turbine system according to claim 1, wherein the predicted wind-condition data generator is configured to learn using generative adversarial networks (GANs) to generate predicted wind-condition data.

3. The wind turbine system according to claim 2, wherein the control algorithm learner is configured to receive data about present states of the wind turbine from the wind turbine, and learn change in the power production efficiency corresponding to change in the control variable.

4. The wind turbine system according to claim 3, wherein the control algorithm learner is configured to provide feedback on change in power production in a form of a loss function, and set the control variable to minimize a result value of the loss function.

5. The wind turbine system according to claim 4, wherein the control variable comprises at least one among a pitch and rotating speed of a blade, and yaw and tilt angles of a tower in the wind turbine.

6. The wind turbine system according to claim 5, wherein the control algorithm learner is configured to make the AI learn with deep deterministic policy gradient (DDPG).

7. The wind turbine system according to claim 1, wherein the controller is configured to measure present wind conditions through a sensor provided in the wind turbine, and control the wind turbine by reflecting an error between the predicted wind-condition data and the present wind-condition value.

8. A wind turbine control method using predicted wind conditions, comprising:
Obtaining time-series wind-condition data at many places within a predetermined distance from a reference position where the wind turbine is placed;
generating predicted wind-condition data at the reference position after a present point in time based on the time-series wind-condition data;
generating a control variable by learning a control algorithm applied to the wind turbine to improve a power production efficiency of the wind turbine based on the predicted wind-condition data; and
controlling the wind turbine based on the generated control variable.

9. The wind turbine control method according to claim 8, wherein the predicted wind-condition data comprises information about wind conditions of a predetermined period from a present point in time to the future, which is generated based on generative adversarial networks (LANs).

10. The wind turbine control method according to claim 9, wherein the learning of the control algorithm is performed based on data about present states of the wind turbine received from the wind turbine, and change in the power production efficiency corresponding to change in the control variable.

11. The wind turbine control method according to claim 10, wherein the learning of the control algorithm is performed to provide feedback on change in power production in a form of a loss function, and set the control variable to minimize a result value of the loss function.

12. The wind turbine control method according to claim 11, wherein the control variable comprises at least one among a pitch and rotating speed of a blade, and yaw and tilt angles of a tower in the wind turbine.

13. The wind turbine control method according to claim 8, wherein the learning of the control algorithm is performed by making the AI learn with deep deterministic policy gradient (DDPG).

14. The wind turbine control method according to claim 8, wherein the controlling of the wind turbine comprises measuring present wind conditions through a sensor provided in the wind turbine, and updating the control variable by reflecting an error between the predicted wind-condition data and the present wind-condition value.
